(19) United States
(12) Patent Application Publication
(10) Pub. No.: US 2021/0130201 A1
(43) Pub. Date: May 6, 2021

(54) METHOD AND APPARATUS FOR IN-SITU REMOVAL OF PER- AND POLY-FLUOROALKYL SUBSTANCES

(71) Applicant: Kerfoot Technologies, Inc., Mashpee, MA (US)

(72) Inventor: William B. Kerfoot, Falmouth, MA (US)

(73) Assignee: Kerfoot Technologies, Inc., Mashpee, MA (US)

(21) Appl. No.: 17/074,745

(22) Filed: Oct. 20, 2020

Related U.S. Application Data
(60) Provisional application No. 62/931,510, filed on Nov. 6, 2019.

(51) Int. Cl. C02F 1/72; C02F 1/00; C02F 1/78; B09C 1/08; B09C 1/00; C02F 1/28

(52) U.S. Cl. CPC C02F 1/725; C02F 1/008; C02F 1/78; C02F 1/722; C02F 2103/06; B09C 1/002; C02F 1/281; C02F 1/283; B09C 1/08

(57) ABSTRACT

Apparatus and method for removing PFAS compounds from contaminated groundwater or soil includes a well having diffusers for injecting gaseous ozone as bubbles into water in the groundwater or soil formation, a catalytic adsorption canister having an inlet and at least one outlet coupled to the groundwater or soil formation; a control mechanism for supplying gaseous ozone to the well and the catalytic adsorption canister, and a pump in the well, the pump having an inlet for receiving groundwater from an upper portion of the well, a first outlet coupled to a lower portion of the well and a second outlet coupled to the inlet of the catalytic adsorption canister. The catalytic adsorption canister, which can also be used as a stand-alone system for ex-situ treatment of groundwater, includes a mineral catalyst to adsorb PFAS compounds, which are thereafter mineralized and decomposed by exposure of ozone bubbles.

### CROSS-REFERENCE TO RELATED APPLICATION

This application claims the benefit of U.S. Provisional Application No. 62/931,510, filed Nov. 6, 2019, which is incorporated herein by reference in its entirety.

### TECHNICAL FIELD OF THE INVENTION

The present invention generally relates to methods and apparatus for soil and groundwater treatment. More particularly, the present invention relates to methods and apparatus for reducing or eliminating per- and poly-fluoroalkyl substances (PFASs) concentrations in soil and groundwater.

### BACKGROUND OF THE INVENTION

Perfluoroalkyl compounds such as PFOS (perfluoroalkyl sulfonate) and PFOA (perfluoroalkyl octanoic acid) are human-made substances, not naturally found in the environment, which do not hydrolyze, photolyze, or biodegrade in groundwater or soil. These compounds have been used as surface-active agents in a variety of products such as fire-fighting foams, coating additives and cleaning products. The toxicity and bioaccumulation potential of PFOS and PFOA, however, indicate a cause for concern. For example, studies have shown they have the potential to bioaccumulate and biomagnify up fish food chains. Products containing perfluoroalkyl compounds are readily absorbed after oral intake and accumulate primarily in the serum, kidney, and liver. Health-based advisories or screening levels for PFOS and PFOA have been developed by both the EPA and by an increasing number of States (Alaska, Maine, etc.) and European Countries (Finland, Sweden, Netherlands). Within the USA, Canada, and Europe (EU), there are an estimated 1000 sites which have been used for fire foam training for aviation crashes with soil contamination (soils and groundwater). As a result, there is a need for a process for treating soil and groundwater at such sites, as well as others polluted with PFOS, PFOA, and similar contaminants.

Other contaminants in this group include perfluorooctane sulfonate (PFOS), perfluorooctanoic acid (PFOA), perfluorohexane sulfonate (PFHxS), perfluorohexanoic acid (PFHxA), perfluoropentanoic acid (PFPeA), perfluorobutane sulfonate (PFBS), perfluorodecanoic acid (PFDA), perfluorobutanoic acid (PFBA) perfluorodecanoic acid (PFDoA), pertluoroheptanoic acid (PFHpA), perfluorononanoic acid (PFNA), perfluoroctane sulfonamide (PFOSA), perfluoroundecanoic acid (PFUnA) and any combination of these. Collectively, these contaminants are commonly referred to as per- and poly-fluoroalkyl substances (PFAS).

Recently, remediation of PFASs has changed considerably. Numerous states are reviewing groundwater and soil contamination standards for a minimum containment level (MCL) of PFASs. Massachusetts, for example, has identified six homologs for critical control: PFOS. PFOA, PFNA, PFHxS, PFHpA, and PFDA. These six homologs are generally known as the PFOS Six. Specifically, the Massachusetts Department of Environmental Protection has established final PFAS Maximum Contaminant Levels (MCL) for drinking water at 20 ppt, which applies to the total summed concentration level of all six compounds. It is believed that other states and countries will apply similar standards, and thus it is important to utilize remediation methods that can treat contaminated soil and groundwater to effectively reduce the levels of the PFOS Six, as well as similar contaminants.

Often, a contaminated site is treated by using a sparging well to deliver an oxidant at a depth below the surface using a well and one or more diffusers which deliver microbubbles to the groundwater and soil. Such a system is described in U.S. Pat. No. 8,302,939 to Kerfoot, titled “Soil and Water Remediation System and Method,” which is incorporated herein by reference. This patent is a continuation-in-part of U.S. patent application Ser. No. 10/997,452, filed Nov. 24, 2004, now U.S. Pat. No. 7,537,706, which is a continuation of U.S. patent application Ser. No. 09/943,111, filed Aug. 30, 2001, now U.S. Pat. No. 6,872,318, which is a continuation of U.S. patent application Ser. No. 09/606,952, filed Jun. 29, 2000, now U.S. Pat. No. 6,284,143, which is a continuation of U.S. patent application Ser. No. 09/220,401, filed Dec. 24, 1998, now U.S. Pat. No. 6,083,407, which is a continuation of U.S. patent application Ser. No. 08/756,273, filed Nov. 25, 1996, now U.S. Pat. No. 5,855,775, which is a-continuation-in-part of U.S. patent application Ser. No. 08/638,017, filed Apr. 25, 1996, now abandoned, which is a continuation-in-part of U.S. patent application Ser. No. 29/038,499, filed May 5, 1995, now abandoned. Each of these applications is incorporated by reference herein in its entirety.

Heretofore, major treatment processes are adsorption-based and do not decompose the PFAS compounds. As a result, the adsorbed leachate needs to be disposed after treatment of groundwater. Locations for disposal of leachate are increasingly limited. Notably, landfills are no longer accepting leachate with PFAS compounds for disposal. Additionally, incineration of leachate with PFAS compounds is far more difficult than for common petroleum alkanes. For example, a temperature above 1200° C. is generally required. Accordingly, a treatment method that reduces the amount of leachate—for example, by mineralizing the perfluoro compound effectively and efficiently—is needed.

The oxidant delivered by a sparging well may be ozone. It may also be ozone that has been catalyzed or modified in some way. For example, U.S. Pat. No. 9,694,401 to Kerfoot, titled “Method and Apparatus for Treating Perfluoroalkyl Compounds,” and incorporated herein by reference, describes a method and apparatus of treating a site containing perfluoroalkyl compounds (PFC) using fine oxygen/ozone gas bubbles delivered with a hydroperoxide coating and solution which is activated by self-created temperature or applied temperature to raise the oxidation potential above 2.9 volts. Once begun, the reaction is often self-promulgating until the PFC is exhausted, if PFC concentrations are sufficiently elevated.

The invention in Kerfoot's U.S. Pat. No. 9,964,401 utilizes a canister comprised of an “adsorber” set above “activated carbon” which receives ozone as a treatment gas. Groundwater is withdrawn from a well, such as a recirculating well placed in an aquifer. The treatment method works well with a silicate-based soil containing up to 8% iron, which reacts with micro to nanobubble ozone as an effective catalyst to decompose perfluoroalkyl compounds by the unzipping process described, regardless of the end group (sulfonic or carboxylic). However, upon further testing, granulated activated carbon (GAC) has been found to be inefficient by (1) premature “breakthrough” of PFAS compounds, and (2) requiring additional means of disposal to destroy the adsorbed PFAS compounds. Accordingly, there is a need for a method using a mineral catalyst that will improve pretreatment in a treatment chain involving activated carbon.

As noted, contaminated sites are generally treated by using an in-situ recirculating sparging well. However, there is further a need for an ex-situ decomposition process and apparatus to further avoid spreading contamination, as well as to treat groundwater or drinking water above ground. In this regard, there is a need for a stand-alone adsorption canister to improve the ease and efficiency of contaminant treatment.

Although the methods and apparatus described above are capable of removing a very high percentage of PFASs from a contaminated site, further techniques are needed to meet new and anticipated future standards for groundwater and soil contamination. The present invention addresses these issues, and provides a means to improve upon the associated limitations of prior art methods and apparatus for soil and groundwater treatment.

### SUMMARY OF THE INVENTION

The present invention is directed to apparatus and methods for soil and groundwater treatment utilizing a catalytic adsorption canister that uses a mineral catalyst that can adsorb PFAS in the soil and/or groundwater, and further, in the presence of ozone nano- and micro-bubbles, mineralize and/or decompose PFAS compounds.

Ina first aspect of the present invention, a catalytic adsorption canister is provided in a well having at least one diffuser for injecting gaseous ozone as bubbles into water in the groundwater or soil formation. The catalytic adsorption canister includes an inlet and at least one outlet coupled to the groundwater or soil formation. A control mechanism is provided for supplying gaseous ozone to the well and the catalytic adsorption canister. A pump, preferably provided within the well, includes an inlet for receiving groundwater from an upper portion of the well, a first outlet coupled to a lower portion of the well and a second outlet coupled to the inlet of the catalytic adsorption canister. In operation, an aqueous solution being treated is adsorbed by a mineral catalyst in the catalytic adsorption canister, which is then exposed to nano- or micro-bubble ozone, which decomposes the perfluoro compound into its mineral components.

In a second aspect of the present invention, the catalytic adsorption canister can comprise a stand-alone system, combined with activated carbon, that can be used for ex-situ treatment of groundwater above-ground. Preferred embodiments of such a stand-alone catalytic adsorption canister comprise an upper adsorber chamber including a mineral or sand-based catalyst; a lower adsorber chamber including activated carbon or charcoal; a first inlet for receiving water for treatment; and a second inlet for receiving gaseous ozone bubbles. Outlets are also provided for discharging the treated water and gas (e.g., oxygen) from the system. In operation, the mineral catalyst in the upper adsorber chamber adsorbs PFAS compounds in contaminated water introduced to the upper adsorber chamber, and, in the presence of the gaseous ozone bubbles, the PFAS compounds are mineralized and decomposed.

In accordance with the present invention, a mineral catalyst is used as an adsorbent to promote the unraveling (or unzipping) of the perfluoroalkane molecules when exposed to nano- or micro-bubble ozone. Preferably, the mineral catalyst has a strong affinity for the compounds being treated (e.g., PFOS) such that the adsorption occurs quickly and efficiently through a first treatment cycle. By combining adsorption with a catalyst which initiates unzipping of the alkane C—F backbone of the molecule in the presence of ozone, the perfluoro compound can be mineralize efficiently and effectively. Moreover, the fine bubbles (e.g., almost cloud-like nano- and micro-bubbles), when exposed to the mineral catalyst, has good reactivity on the surface of the catalyst to speed up the rate of decomposition. Nanobubble ozone is preferred over microbubbles due to improved rate of decay, though either can be used without departing from the principles and spirit of the present invention and are collectively referred to herein.

In embodiments of the present invention, a plurality of diffusers is provided and arranged in series. Further, the diffusers are operatively coupled to the control mechanism for receiving gaseous ozone and producing bubbles, more preferably fine bubbles (i.e., nano- and micro-bubbles), that are introduced into the groundwater or soil formation to effect removal of PFAS compounds.

In embodiments, the control mechanism supplies hydroperoxide. In alternate embodiments, treatment can be accomplished without peroxide added, and instead supply ozone nanobubbles. For example, the control mechanism can supply sodium hydroxide or potassium hydroxide.

In embodiments of the present invention, the diffusers are operatively coupled to the control mechanism for receiving gaseous ozone and liquid hydroperoxide and producing a plurality of peroxide-coated ozone bubbles that are introduced into the groundwater or soil formation to effect removal of PFAS compounds. Further, the plurality of peroxide-coated ozone bubbles may have a diameter less than about 10 μm, wherein the bubbles have an oxidation potential greater than or equal to 2.9 volts and less than or equal to 3.6 volts, and wherein the bubbles contain gas phase ozone at a concentration greater than or equal to 1000 ppmV.

In alternate embodiments, without peroxide added, the diffusers are operatively coupled to the control mechanism for receiving gaseous ozone and introducing a plurality of microfine ozone bubbles into the catalytic adsorption canister to effect mineralization of PFAS compounds. More particularly, the ozone bubbles interact with the PFAS molecules adsorbed on the surface of the catalytic mineral disposed within the catalytic adsorption canister, whereby the molecule detaches from the mineral surface with the molecular alkaline tail entering the negatively charged surface of the ozone and attempting to enter the gaseous ozone phase.

In embodiments of the present invention, the control mechanism may supply peroxide-coated ozone bubbles to the adsorption canister. In alternate embodiments, the control mechanism may supply ozone bubbles coated with sodium hydroxide or potassium hydroxide.

In another aspect of the present invention, a catalytic adsorption canister is provided in a double-screened well having an upper well screen and a lower well screen for promoting re-circulation of water through the surrounding ground/aquifer region. The recirculation well releases fine ozone bubbles at the base of the double-screened well. As the ozone bubbles travel vertically due to buoyancy, they lift the water towards the upper well screen, with the water movement in the soil being downward from the top of the upper well screen. The fine bubbles exit the upper screen area with the water flow such that the rate of removal of aqueous PFAS is greatest within the well and secondly in the upper portions of the soil. As the ozone bubbles change depth, the pressure decreases on them allowing some expansion, and they rise faster inside the well casing. Liquid flow (e.g., either peroxide or hydroxide) can be delivered to a laminar point to coat the bubbles or change the pH to enhance maction with PFAS compounds. A mineral catalyst can be placed around the bubbling porous screen of the bubble generator to enhance reaction rate. The size and weight of the minerals will keep the suspended particles in the lower well screen.

In any of the above embodiments, the quantity of groundwater sent to the first and second outlets of the pump is adjustable.

The present invention also provides methods of removing perfluoroalkyl substances (PFASs) from a groundwater or soil formation. In an aspect of the present invention, a treatment method comprises injecting gaseous ozone through porous materials in a well to introduce bubbles through an outlet in the well into the groundwater or soil formation at concentrations sufficient to react with, and effect removal of, one or more PFAS contaminants in the groundwater or soil formation. More particularly, groundwater is pumped from the well into a catalytic adsorption canister containing a mineral catalyst and having an outlet coupled to the groundwater or soil formation. The mineral catalyst adsorbs the PFAS compound from the aqueous groundwater solution. Gaseous ozone is injected into the adsorption canister to effect decomposition of PFAS compounds through unraveling (or unzipping) of the C—F bonds of the perfluoroalkane molecules when exposed to the ozone bubbles.

In further embodiments of the present invention, as noted, the catalytic adsorption canister comprises a stand-alone system, combined with activated carbon, that can be used for ex-situ treatment of groundwater or drinking water above ground. Treatment methods include introducing contaminated water is into an upper adsorber chamber within the canister, where the water is adsorbed by a mineral catalyst. Gaseous ozone is also injected through porous materials at the bottom of the upper adsorber chamber within the canister to introduce ozone bubbles into the upper adsorber chamber at concentrations sufficient to react with, and effect decomposition of, the PFAS contaminants upon exposure to the ozone bubbles. The PFAS compound is mineralized over time and flows out of the upper adsorber chamber into and through a lower adsorber chamber containing activated carbon or charcoal. A first outlet of the catalytic adsorption canister is provided for release of oxygen gas. A second outlet is provided for water flow out of the catalytic adsorption canister.

In any of the above-described embodiments, the catalytic adsorption canister may include an upper adsorber region or chamber including a mineral or sand-based catalyst and a lower adsorber region or chamber including activated carbon or charcoal. Further, the upper adsorber region or chamber of the catalytic adsorption canister may include a catalyst with an iron content greater than about 3%, generally in the range of around 8 to 9%. Ozone may be injected into the upper adsorber region or chamber either in a continuous manner, which will generally expose the adsorbed PFAS molecules to a high concentration of ozone bubbles, or an intermittent manner, which will expose the adsorbed PFAS molecules to a lower concentration but allow for treatment at intervals.

In other embodiments, the treatment method includes injecting gaseous ozone into the groundwater or soil formation at a plurality of points along a vertical axis. Still further, fine ozone bubbles can be released at the base of a double-screened well such that, as the ozone bubbles travel vertically due to buoyancy, they lift the water towards an upper well screen, with the water movement in the soil being downward from the top of the upper well screen. The fine bubbles enter the upper screen area with the water flow such that the rate of removal of aqueous PFAS is greatest within the well and secondly in the lower portions of the soil. As the ozone bubbles change depth, the pressure decreases on them allowing some expansion, and they rise faster outside the well casing. Liquid flow (e.g., either peroxide or hydroxide) can be delivered to a lower laminar point under the screened casing to coat the bubbles or change the pH to enhance reaction with PFAS compounds. A mineral catalyst can be placed around the bubbling porous screen of the bubble generator to further enhance reaction rate.

In any of the above-described embodiments of the present invention, the method may include a step of injecting a plurality of peroxide-coated ozone bubbles into the soil formation to effect removal of PFAS compounds. Further, the peroxide-coated ozone bubbles preferably have a diameter less than about 10 μm, wherein the bubbles have an oxidation potential greater than or equal to 2.9 volts and less than or equal to 3.6 volts, and wherein the bubbles contain gas phase ozone at a concentration greater than or equal to 1000 ppmV.

In the alternate, the method may include a step of injecting a plurality of ozone nanobubbles into the soil formation to effect removal of PFAS compounds. The ozone may comprise sodium hydroxide or potassium hydroxide. Further, the ozone bubbles preferably have a diameter in the range of about 10 μm to about 0.25 μm wherein the bubbles have an oxidation potential greater than or equal to 2.9 volts and less than or equal to 3.6 volts, and wherein the bubbles contain gas phase ozone at a concentration greater than or equal to 1000 ppmV.

In other embodiments, the method includes a step of injecting either ozone bubbles or peroxide-coated ozone bubbles directly into the catalytic adsorption canister.

In any of the above-described embodiments, the quantity of groundwater sent to the outlet of the well and/or the adsorption canister can be adjustable.

These and other features of the present invention are described with reference to the drawings of preferred embodiments of an apparatus for treatment of soil and groundwater. The illustrated embodiments of features of the present invention are intended to illustrate, but not limit the invention.

### BRIEF DESCRIPTION OF THE FIGURES

FIG. 1 shows an embodiment of a system for removing PFAS contaminants from a groundwater or soil formation in accordance with the present invention.

FIG. 2 shows a first embodiment of a recirculation well for use with the removal system of FIG. 1.

FIG. 3 shows a second embodiment of a recirculation well for use with the removal system of FIG. 1.

FIG. 4 shows a schematic diagram of the removal systems of FIGS. 2 and 3 with groundwater flow.

FIG. 5 shows a schematic diagram of the removal system of FIG. 1 with groundwater flow meters.

FIG. 6 shows a third embodiment of a recirculation well for use with the removal system of FIG. 1.

FIGS. 7-11 show test results for various conditions when remediating PFAS compounds using the removal system of FIG. 1.

FIG. 12 shows a table of results using the removal system of FIG. 1 with partitioning of PFAS compounds on soil and groundwater.

FIG. 13 is a flow sequence showing exemplary operation of the removal system of FIG. 1.

FIG. 14 shows a first embodiment of a stand-alone catalytic adsorption canister is accordance with the present invention.

FIG. 15 shows a second embodiment of a stand-alone catalytic adsorption canister in accordance with the present invention.

FIG. 16 shows a schematic diagram of an ozone nanobubble.

FIG. 17 shows a schematic diagram of the molecular structure of an ozone nanobubble with peroxide coating.

FIG. 18 shows test results for removal of various PFAS compounds over time using treatment methods in accordance with the present invention.

FIG. 19 shows test results for removal of PFAS compounds over time using ozone bubbles in comparison with peroxide-coated ozone bubbles.

### DETAILED DESCRIPTION OF EMBODIMENTS

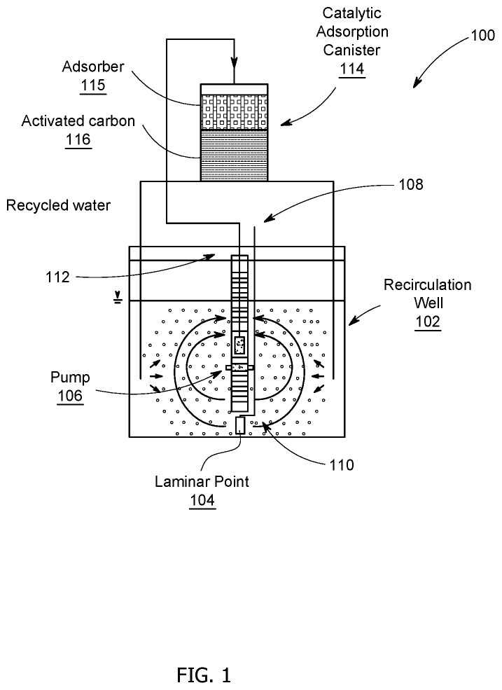

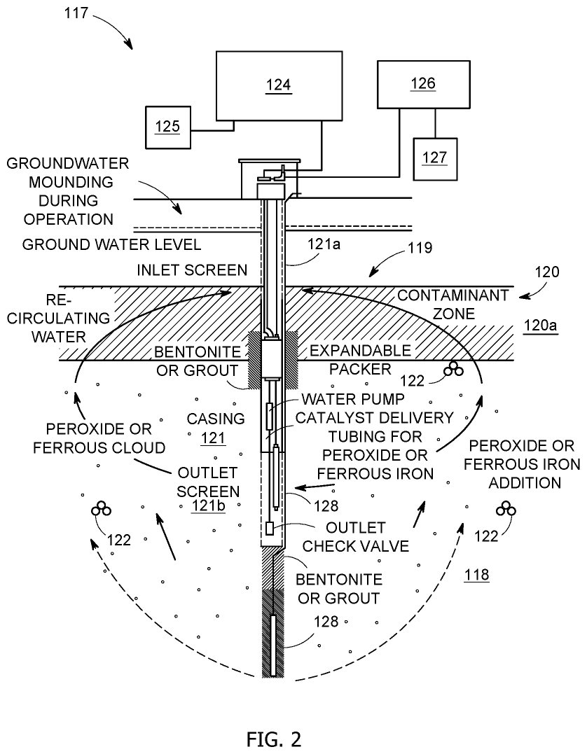

FIG. 1 shows an embodiment of a system for removing PFAS contaminants from a groundwater or soil formation in accordance with the present invention. In FIG. 1, the system is generally designated as reference numeral 100. For clarity of illustration, some control mechanisms are not shown, though they are of the type and design generally understood in the art. A recirculation well (generally designated as reference numeral 102 and described in more detail in connection with FIG. 2) is shown inserted into an area of contamination. A laminar point diffuser 104, generally located at the bottom of the well 102, receives gas and ozone from a control mechanism (not shown) and generates bubbles, preferably fine nano- or micro-bubbles) which are introduced into the soil and groundwater surrounding the recirculation well. A second diffuser (not shown) is located inside the recirculation well 102. A pump 106 inside the well 102 takes groundwater from an inlet 108 in an upper portion of the well 102 and pumps it through a first outlet 110 into the lower portion of the well 102. This creates a flow of groundwater through the soil around the well 102.

The pump 106 has a second outlet 112 which is coupled to an inlet of a catalytic adsorption canister 114, preferably located above the surface of the ground. In alternate embodiments, the catalytic adsorption canister 114 may be located partially or completely below the surface of the ground. As referred to herein, the catalytic adsorption canister 114 filters the groundwater through an adsorber region, generally designated as reference numeral 115 in FIG. 1, followed by an activated carbon region (or a lower adsorber region), generally designated as reference numeral 116 in FIG. 1. The recycled water is then returned to the contamination site.

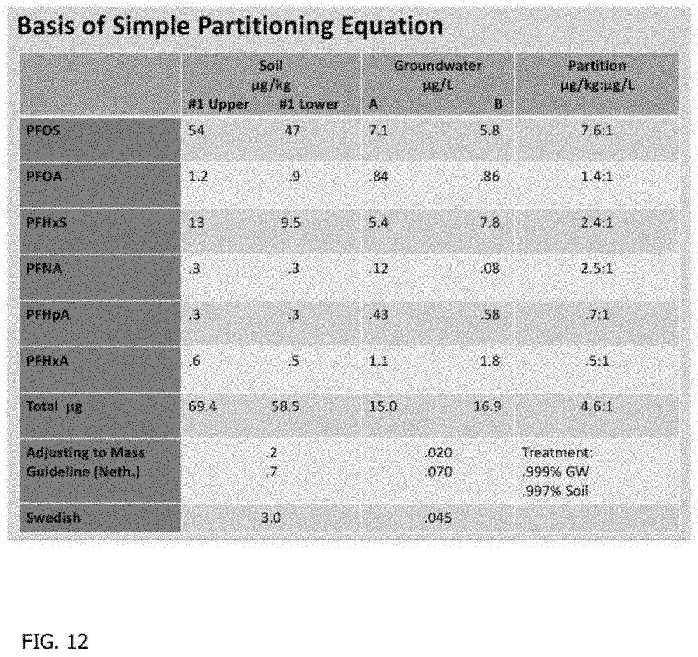

In embodiments of the present invention, the percentages of groundwater sent to the recirculation well 102 and the catalytic adsorption canister 114 may be adjusted depending on the nature of contaminants in the site and other factors, as discussed below in connection with FIG. 12.

In embodiments of the present invention, a control mechanism (not shown) provides a source of ozone gas to the diffusers in the well 102 and to the adsorber region 115 of the catalytic adsorption canister 114. The adsorber region 115 contains a mineral catalyst, preferably an iron silicate mineral. Preferably, the mineral catalyst has an iron-content that is greater than about 3%, and more preferably in the range of about 8 to 9%. The mineral catalyst preferably has a strong affinity for the compound (e.g., PFOS) and promotes the unravelling (or unzipping) of the perfluoroalkane molecules when exposed to nano- or micro-bubble ozone.

In operation, providing catalyzed ozone to the adsorber region 115 removes PFAS contaminants from the aqueous solution (i.e., groundwater) that has been delivered from the pump 106. More particularly, the PFAS attaches to the outside of the mineral catalyst. A compound like PFOS, for example, in water passes through an up-flow filter composed of the mineral catalyst. Adsorption occurs quickly (i.e., within minutes). Before breakthrough occurs from the adsorber region 115, nano- or micro-bubble ozone is generated at the base or bottom of the adsorber region 115, which is water-saturated. The ozone bubbles move upwards within the adsorber region 115, contacting the adsorbed molecules. In a time spell ranging from about one to six hours of exposure, over 90% of the compound is mineralized to carbon dioxide, oxygen, fluoride and sulfate, which flows out of the adsorber region 115 with the water and into and through the activated carbon region 116. A preferential pH level of the mineral catalyst in the range of 9-10 allows the perfluoroalkane molecule to break (or “zip” off) the C—F bonds of the molecules, and detach from the mineral surface with the tail entering the negatively charged surface of the ozone and attempting to enter the gaseous ozone phase. If any compound remains on the soil, it can be treated during a second pass of activated nano- or micro-bubble ozone.

Improved results have been identified using the methods and apparatus of the present invention. By combining adsorption with a mineral catalyst which initiates unzipping of the alkane C—F backbone of the molecule in the presence of ozone, the perfluoro compound can be mineralize efficiently and effectively. Moreover, the fine bubbles (e.g., almost cloud-like nano- and micro-bubbles), when exposed to the mineral catalyst, has good reactivity on the surface of the catalyst to speed up the rate of decomposition. Nanobubble ozone is preferred over microbubbles due to improved rate of decay, though either can be used without departing from the principles and spirit of the present invention and are collectively referred to herein.

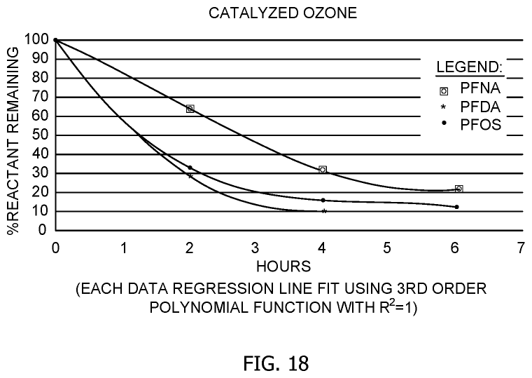

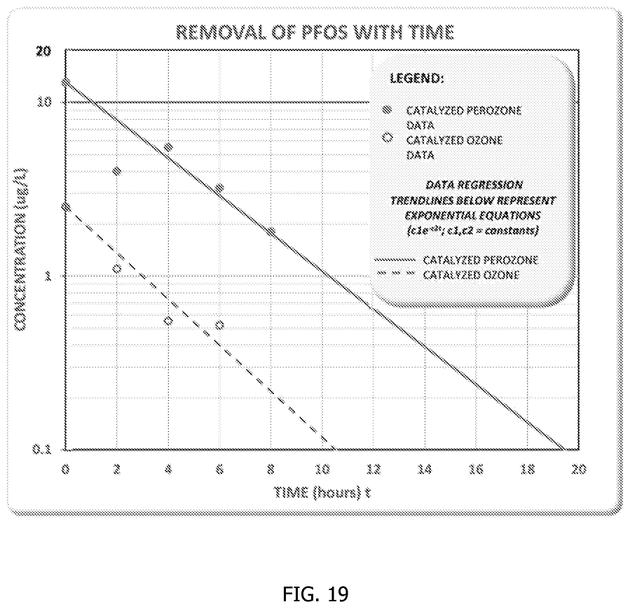

While some embodiments described herein, use peroxide-coated ozone bubbles to effect removal of PFAS compounds within the adsorber region 115, which yields certain benefits, the use of peroxide is not necessary to achieve mineralization of the C—F portion of the molecular alkane tail. Indeed, the use of ozone bubbles, for example, sodium hydroxide or potassium hydroxide, with the mineral catalyst has proven to be quicker, more complete and more cost effective, without compromising treatment efficacy and efficiency, such as illustrated in FIGS. 18-19. Indeed, leftover waste has been reduced, no longer requiring incineration of contaminated soil and leachate.

After passing through the adsorber region 115, the groundwater travels through the activated carbon region 116 and is recycled back into the soil. Adding ozone to the adsorber region 115 of the catalytic adsorption canister 114 effectively cleans the adsorber region 115 and extends the useful life of the activated carbon region 116 of the catalytic adsorption canister 114.

Ozone or other oxidizing agents may be provided to the catalytic adsorption canister 114 in a variety of ways, for example, spraying or dripping into the top or side of the adsorber region 115.

A more detailed depiction of a recirculation well for use with the system of FIG. 1 is shown in FIG. 2. Referring now to FIG. 2, a recirculation well, or sparging arrangement 117, for use with plumes, sources, deposits or occurrences of contaminants in a vadose zone or aquifer 120, is shown. More particularly, sparging arrangement 117 is disposed in a well 119 that has a casing 121 which can include an inlet screen 121a disposed at an upper portion of a well column and an outlet screen 121b disposed at a lower end of the well column. With inlet and outlet screens 121a, 121b, a recirculation well is provided to promote re-circulation of water through the surrounding ground/aquifer region 118. The casing 121 supports the ground about well 119. Disposed through casing 121 are one or more diffusers 128. As illustrated in FIG. 2, two diffusers 128 are provided. In one embodiment, microbubbles of air, air enriched with oxygen, or air and ozone and/or oxygen are emitted into the surrounding formation. Other arrangements can include coated nano- or micro-bubbles, as discussed below. The arrangement of FIG. 2 can further include an expandable packer, but need not include a packer for certain configurations. Alternatively, diffusers that do not have a microporous surface can be used. A water pump and check valve can also be included in the well 119.

Sparging arrangement 117 also includes a compressor/pump and compressor/pump control mechanism 124 to feed a first fluid 125, e.g., a gas such as an ozone/air or oxygen enriched air mixture, into diffuser 128. A second compressor/pump and compressor/pump control mechanism 126 is also coupled to a second fluid source 127 to feed a second fluid, such as, hydrogen peroxide or a peroxide, to some embodiments of diffuser 128. e.g., a multi-fluid diffuser. Catalysts can be delivered to microporous diffusers 128 via tubing. As illustrated in FIG. 2, lower diffuser 128 is embedded in sand below Bentonite or grout. Alternatively, a sand pack (with or as a catalyst) can be placed around the lower diffuser 128. In embodiments, ozonophilic bacteria 122 may be introduced if suitable bacteria are not present or if the bacteria are not present in sufficient quantities to treat volatile organics from spilled fuel.

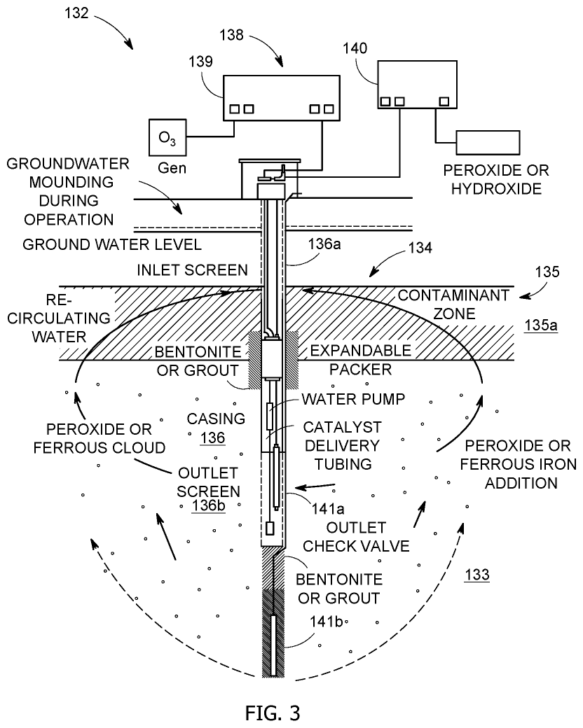

An alternative embodiment of a recirculation well for use in the system of FIG. 1 is shown in FIG. 3. Referring to FIG. 3, a treatment system 132 to treat contaminants in a subsurface aquifer 133 includes a recirculation well, or sparging apparatus 134, that is disposed through a soil formation 135. In this arrangement, the sparging apparatus 134 is disposed through a soil formation 135 comprising a vadose zone 135a and an underlying aquifer 133. The sparging apparatus 134 includes a casing 136 positioned through a borehole disposed through the soil formation 135. Casing 136 has an inlet screen 136a disposed on an upper portion thereof and an outlet screen 136b disposed on a bottom portion thereof. Disposed through casing 136 is a first microporous diffuser 141a. Alternatively, a slotted well-screen could be used. Microporous diffuser 141a preferably comprises a laminate microporous diffuser. A second microporous diffuser 141b is disposed in a borehole that is below the borehole containing casing 136, and is surrounded by a sand pack and isolated by bentonite or a grout layer from the borehole that has first microporous diffuser 141a. Also disposed in the casing 136 is an expandable packer that isolates upper screen 136a from lower screen 136b and appropriate piping to connect sources of decontamination agents to microporous diffusers 141a, 141b.

In operation of the well arrangement 134, when fluid is injected through microporous diffusers 141a, 141b, the packer, screens 136a, 136b and a water pump 136 enable a re-circulation water pattern to be produced in the soil formation, as generally illustrated in FIG. 3. Although an embodiment is shown and described, many variations are possible. For example, the water pump may also be located above the expandable packer.

The arrangement for the treatment system 132 also includes apparatus generally depicted as reference numeral 138 that includes a gaseous decontaminate oxidizer apparatus 139 and a liquid oxidizer supply apparatus 140 that supplies, for example, hydrogen peroxide-employed with Perozone 3.0, a catalyzed Perozone—or a catalyzed ozone without peroxide, such as sodium hydroxide or potassium hydroxide. Generally, the gas sources on the oxidative side can be air, oxygen, and ozone. Some of the sources can be supplied via the ambient air. For example, an oxygen generator and an ozone generator can be used to supply oxygen and ozone from air. The liquid supply apparatus 140 feeds a liquid mixture to the microporous diffusers 141a, 141b. As noted, the liquid source is preferably a solution with hydrogen peroxide, or sodium or potassium hydroxide. The system 132 feeds microporous diffusers 141a, 141b with the gas stream, typically air and ozone, through a central portion of the microporous diffuser producing nano- or micro-bubbles that exanimate from the central portion of the microporous diffuser where they come in contact with the liquid solution. If, for example, the liquid solution includes hydrogen peroxide, nano- or micro-bubbles are produced with a peroxide coating on the bubbles that will be used to effect removal of PFAS compounds during treatment.

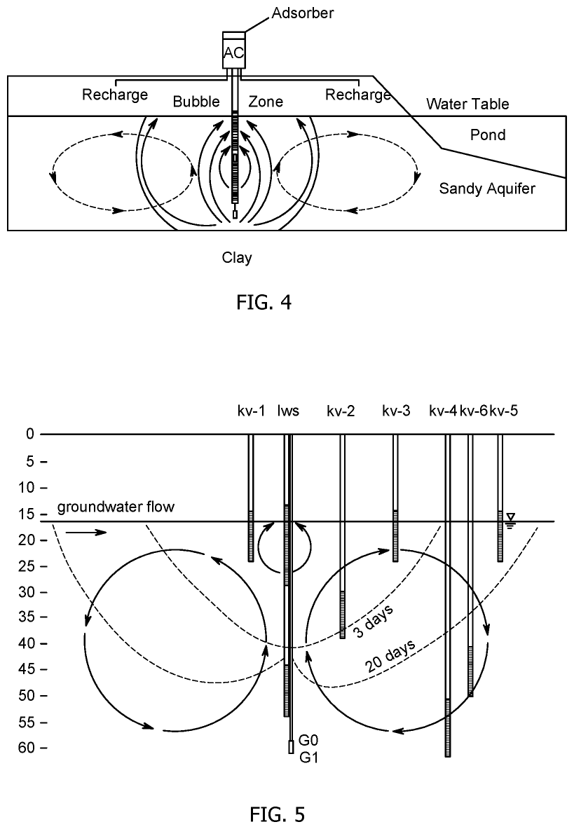

FIG. 4 depicts a cross-sectional view of a removal system in a contamination region. A recirculation well, similar to those illustrated in FIG. 2 or 3, is inserted below the water table into a sandy aquifer region. A bubble zone indicates an area that has been contaminated with PFAS compounds. A catalytic adsorption canister is located above ground over the well. A pump in the recirculation well pulses intermittently to cause a flow of groundwater as shown by the solid arrows. As this flow is established, a gyre circulation is set up as shown by the dotted arrows. Groundwater from the catalytic adsorption canister is recycled into the contamination area outside the bubble zone. In embodiments of the present invention, the recharge water would also be outside the gyre circulation of groundwater. In certain embodiments, there can be a single outlet of recharge water from the catalytic adsorption canister, however, in alternative embodiments, there may be two outlets, as shown in FIG. 4, or as many as four outlets.

FIG. 5 depicts a schematic diagram of a removal system of FIG. 1 in accordance with the present invention, indicated at IWS in FIG. 5 together with a plurality of groundwater flow meters, designated as KV-1 through KV-6. In an embodiment, groundwater flow meters, similar to those disclosed in U.S. Pat. No. 4,391,137 to Kerfoot, incorporated herein by reference, may be used to monitor the progress of removing PFAS compounds from the site. The flow meters are capable of measuring a direction and rate of flow in both horizontal and vertical directions. Nesting several flow meters, as shown, for example, with flow meters KV-3, KV-4, KV-5 and KV-6, allows the detection of groundwater flow in terms of vectors. The circular arrows provided in FIG. 5 illustrate a gyre formation around well IWS, as well as a zone of influence by dissolved oxygen (in days).

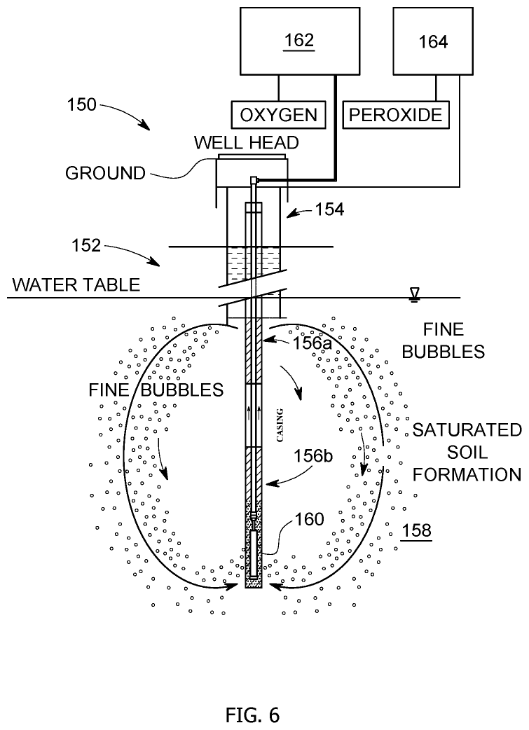

FIG. 6 illustrates an alternate embodiment of a recirculation well in accordance with the present invention. The illustrated treatment system, generally designated as reference numeral 150, comprises a sparging arrangement 152 disposed in a double-screened well 154 having an upper well screen 156a disposed at an upper portion of a well column and a lower well screen 156b disposed at a lower end of the well column. With upper and lower screens 156a, 156b, a recirculation well is provided to promote re-circulation of water through the surrounding ground/aquifer region 158. The recirculation well 154 releases fine ozone bubbles at the base of the double-screened well 154. As the ozone bubbles travel vertically due to buoyancy, they lift the water towards the upper well screen 156a. The fine bubbles exit the upper screen area with the water flow. The bubble size can be oscillated between very fine bubble and microbubble to control the bubble size distribution. As the ozone bubbles change depth, the pressure decreases on them allowing some expansion, and they rise faster inside the well casing. Liquid flow (e.g., either peroxide or hydroxide) can be delivered to a laminar point to coat the bubbles and/or change the pH to enhance reaction with PFAS compounds. Iron silicate catalyst minerals can be placed around the bubbling porous screen of a bubble generator 160 within the well 154 to enhance reaction rate. The size and weight of the minerals will keep the suspended particles in the lower well screen 156b.

In operation of the system 150, the water movement is down from the top of the upper well screen 156a, as illustrated by the arrows in FIG. 6. The rate of removal of aqueous PFAS is greatest within the well 154 and secondly in the upper portions of the soil.

The recirculation well 154 can operate on ozone micro- to nano-bubbles without peroxide by using the mineral catalyst alone. Periodically, the catalyst particles will need to be pumped out and renewed. The top of the well 154 should be capable of being sealed. Normally, a ¾ to 1-inch pipe sends ozone gas from a control mechanism 162 to the bubble generator 160. Riser pipe construction can be PVC, CPVC, or stainless steel. Peroxide is delivered with a % inch HDPE tube from a perozone control mechanism 164. Riser pipe, tubing, and Spargepoint® can be readily removed from the well 154 for replacement, as needed.

In each of the recirculation well embodiments described herein, treatment is most efficient when the PFAS contaminated soil is shallow, grading to lower concentrations near the base of the well. The permeability of the soil should be greater than 10⁻⁶ cm/sec to allow fine bubbles through the saturated soil. Ozone concentration should be greater than 1000 ppmV. Peroxide concentration, when used, should be 8 ppm or greater, but less than 20 ppm, if used.

Well construction is usually PVC, CPVC, or HDPE with 10 or 20 slot screens and 4-inch ID. Porous materials may be porous stainless steel.

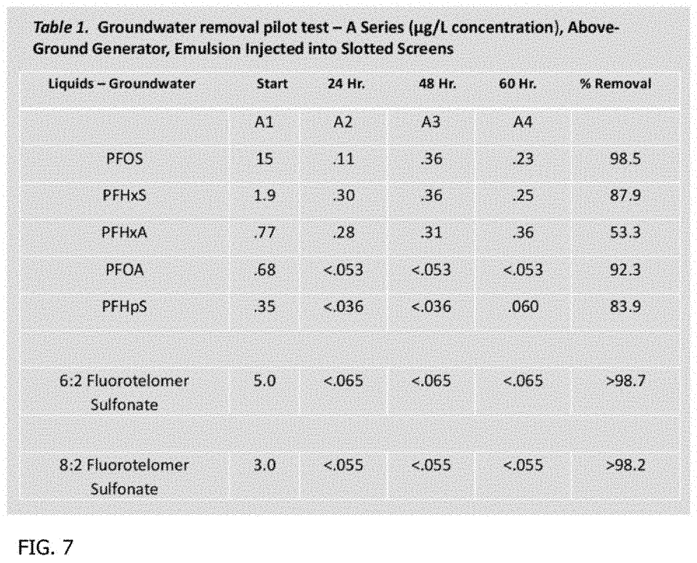

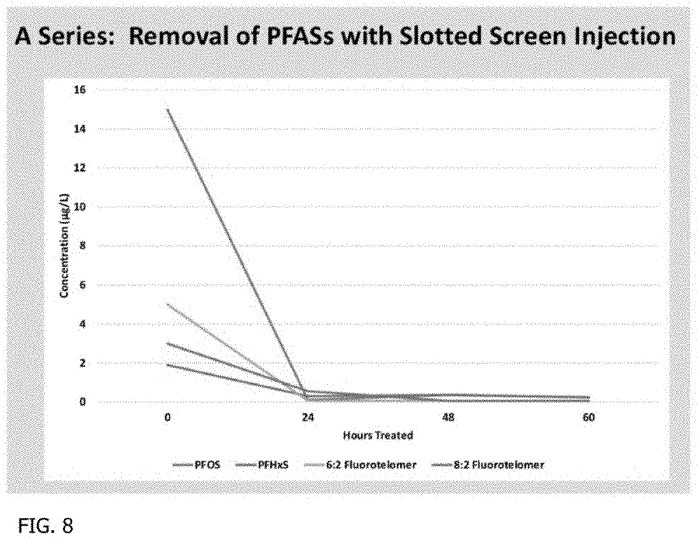

FIG. 7 shows a table illustrating a groundwater removal test where 7 liquids were tested at 4 intervals. FIG. 8 shows one exemplary graph illustrating the results for four of the liquids of the table of FIG. 7 in graph form.

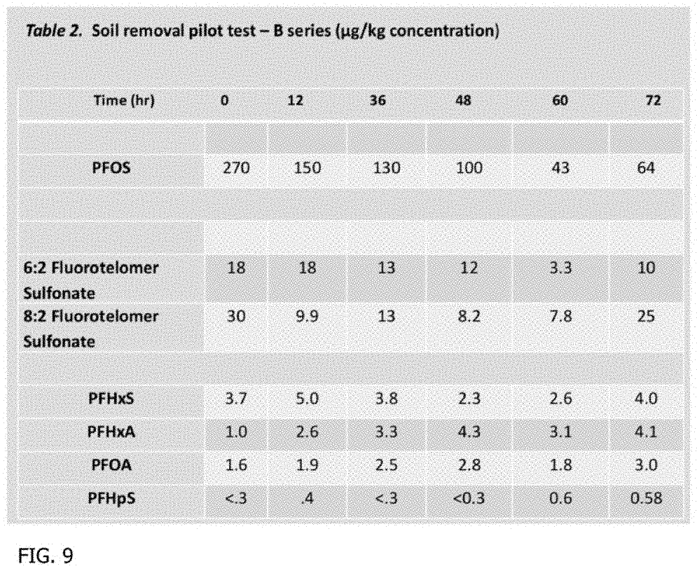

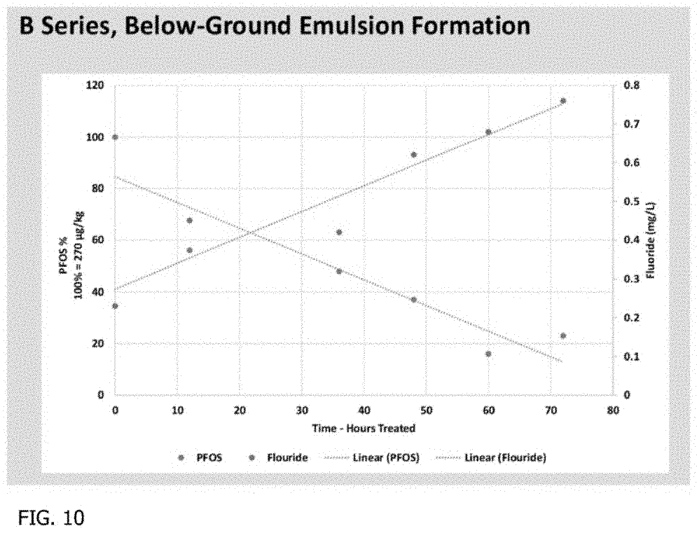

FIG. 9 shows a table illustrating a soil removal test for the same 7 liquids of FIG. 7. The soil was tested 6 times over a 72-hour period. FIG. 10 shows one exemplary graph illustrating a rise in fluoride concentration with the decomposition of PFOS during the removal process.

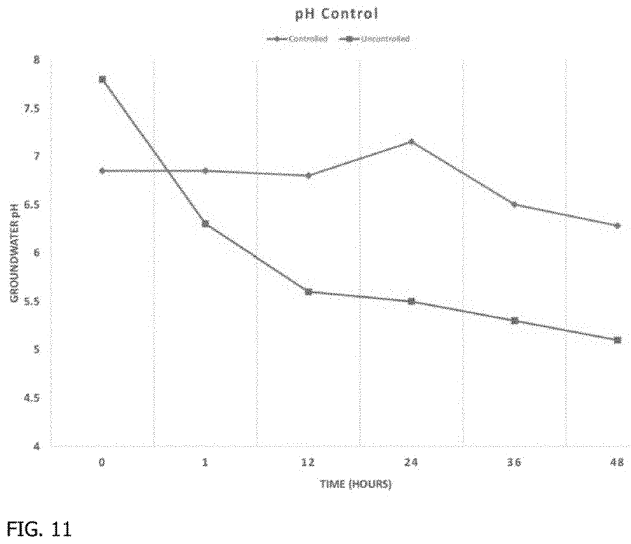

FIG. 11 shows one exemplary graph illustrating a change in pH of groundwater during a 48-hour removal process.

As noted above, the partitioning of PFOS, for example, between soil and groundwater changes with the compound, depending on the nature of contaminants in the site and other factors. FIG. 12 shows the impact that various ratios between these concentrations have on the removal percentage of PFAS compounds necessary to reach MCLs.

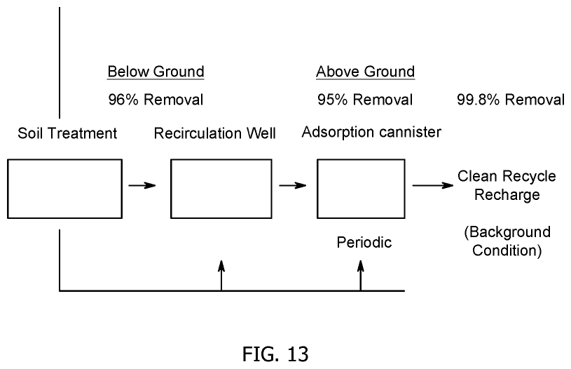

A flow schematic of a method for use with the removal system of FIG. 1 is shown in FIG. 13. An oxidizing agent such as ozone is used to treat soil containing groundwater below ground through the use of a recirculation well, such as the embodiments illustrated in FIGS. 2, 3 and 6. This treatment approach results, for example, in removal of 95% of PFAS compounds. A portion of groundwater from the recirculation well is sent to the catalytic adsorption canister, located above ground, which removes 95% of any remaining PFAS compounds. The combination of these two methods results in at least a 99.8% removal of PFAS compounds from the groundwater and soil.

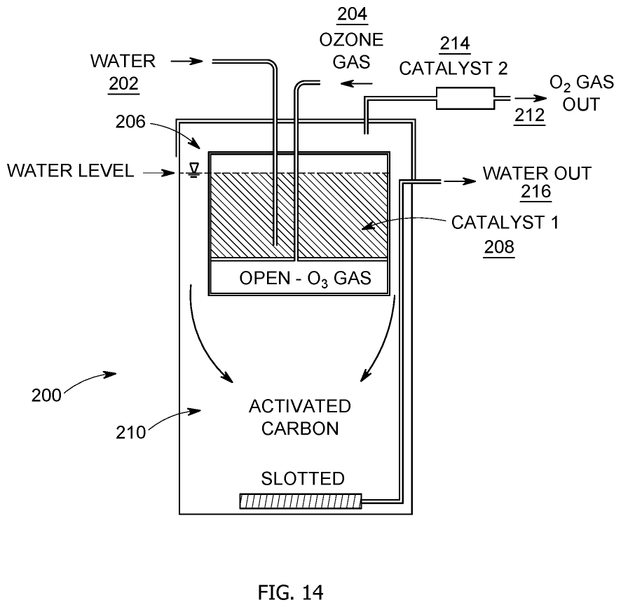

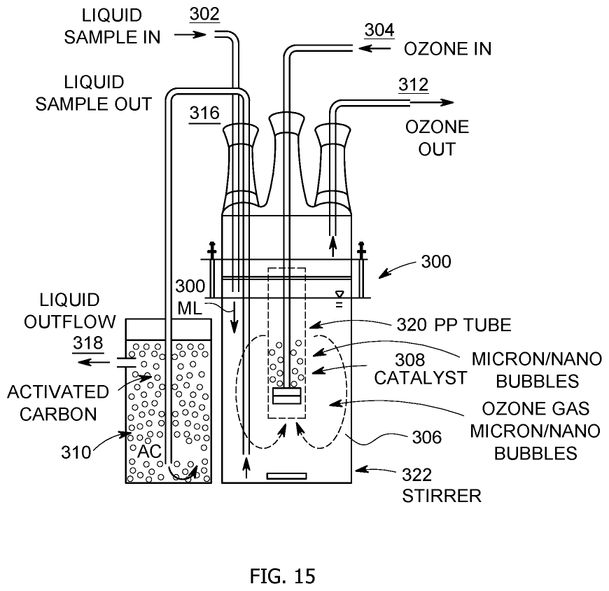

The present invention also has utility for treating contaminated soil and groundwater using a catalytic adsorption canister as a stand-alone system, combined with activated carbon. Such a design can be used for ex-situ treatment of groundwater or drinking water above ground, apart from a well set-up. Embodiments of such a stand-alone catalytic adsorption canister are illustrated in FIGS. 14-15.

Referring to FIG. 14, a stand-alone catalytic adsorption canister 200 is illustrated. In accordance with a preferred embodiment of such a stand-alone canister, the catalytic adsorption canister 200 includes a first inlet 202 for receiving groundwater for treatment, and a second inlet 204 for receiving gaseous ozone. The catalytic adsorption canister 200 includes an upper adsorber chamber 206 including a mineral or sand-based catalyst 208 and a lower adsorber chamber 210 (or activated carbon chamber) including activated carbon or charcoal. A first outlet 212 of the catalytic adsorption canister 200 is provided for release of oxygen gas and any other byproduct from the decomposition of the PFAS compounds in the water to be treated. A second catalyst 214 can be provided for further treatment of this released gas. A second outlet 216 is provided for water flow out of the catalytic adsorption canister 200.

In accordance with the present invention, the mineral catalyst 208 is used as an adsorbent to promote the unraveling (or unzipping) of the perfluoroalkane molecules when exposed to nano- or micro-bubbles ozone. Preferably, the mineral catalyst 208 has a strong affinity for the compounds being treated (e.g., PFOS) such that the adsorption occurs quickly and efficiently through a first treatment cycle. In accordance with preferred embodiments, the upper adsorber chamber 206 of the catalytic adsorption canister 200 includes an iron silicate mineral catalyst. Preferably, the mineral catalyst 208 has an iron content greater than about 3%, and more preferably in the range of about 8 to 9%. Further, the mineral catalyst 208 in the upper adsorber chamber 206 comprises a mineral sized 18 to 40 sieve, with a porous membrane sized 10 μm to 0.25 μm, through which ozone gas passes as nano- or micro-bubbles.

Treatment methods include introducing contaminated water is into the upper adsorber chamber 206 within the canister 200, where the water is adsorbed by the mineral catalyst 208. Gaseous ozone is also injected into an open space at the bottom of the upper adsorber chamber 206. The ozone enters into the mineral catalyst 208 through porous materials at the bottom of the upper adsorber chamber 206 within the canister 200 to introduce ozone bubbles into the upper adsorber chamber 206 at concentrations sufficient to react with, and effect decomposition of, the PFAS contaminants upon exposure to the ozone bubbles. Preferably, the porous materials are about 5 μm, permitting nano- and micro-bubbles to pass into the mineral catalyst 208. The PFAS compound is mineralized over time and flows out of the upper adsorber chamber 206 into and through the lower adsorber chamber 210 containing activated carbon or charcoal.

More particularly, the PFAS attaches to the outside of the mineral catalyst 208. A compound like PFOS in water passes through an up-flow filter composed of the mineral catalyst 208. Adsorption occurs quickly (i.e., within minutes). Before breakthrough occurs from the upper adsorber chamber 206, nano- or micro-bubble ozone is generated at the base or bottom of the upper adsorber chamber 206, which is water-saturated. The ozone bubbles move upwards within the upper adsorber chamber 206, contacting the adsorbed molecules. In a time spell ranging from about one to six hours of exposure, over 90% of the compound is mineralized to carbon dioxide, oxygen, fluoride and sulfate, which flows out of the upper adsorber chamber 206 with the water and into and through the lower adsorber chamber 210. A preferential pH level of the mineral catalyst 208 in the range of 9-10 allows the perfluoroalkane molecule to break (or “zip” off) the C—F bonds of the molecules, and detach from the mineral surface with the tail entering the negatively charged surface of the ozone and attempting to enter the gaseous ozone phase. If any compound remains on the soil, it can be treated during a second pass of activated nano- or micro-bubble ozone.

The first outlet 212 of the catalytic adsorption canister 200 is provided for release of oxygen gas and any other byproduct from the decomposition of the PFAS compounds in the water to be treated. The second outlet 216 is provided for water flow out of the catalytic adsorption canister 200 after treatment.

Ozone may be injected into the upper adsorber chamber 206 either in a continuous manner, which will generally expose the adsorbed PFAS molecules to a high concentration of ozone bubbles, or an intermittent manner, which will expose the adsorbed PFAS molecules to a lower concentration but allow for treatment at intervals.

Referring to FIG. 15, an alternate stand-alone catalytic adsorption canister design is illustrated. This catalytic adsorption canister, generally designated as reference numeral 300, operates in a similar fashion as the stand-alone canister 200 shown in FIG. 14 but with an activated carbon chamber 316 that is separated from an adsorber chamber 306. As illustrated, a first inlet 302 supplies groundwater for treatment to the adsorber chamber 306. A second inlet 304 supplies gaseous ozone to the adsorber chamber 306. Similarly, a first outlet 312 of the catalytic adsorption canister 300 is provided for release of ozone gas and any other byproduct from the decomposition of the PFAS compounds in the water to be treated from the adsorber chamber 306. A second outlet 316 is provided for water flow out of the adsorber chamber 306 and into the separate activated carbon chamber 310. A third outlet 318 is provides for water to flow out of the activated carbon chamber 310 after treatment.

A mineral catalyst 308 is provided in a PP tube settler 320 disposed within the adsorber chamber 306 to adsorb PFAS compounds from the water, and through which ozone gas pass as nano- or micro-bubbles for mineralizing the PFAS from the catalyst 308. A stirrer 322 is provided in the catalytic canister 300 for agitating the aqueous solution within the adsorber chamber 306. With lower PFAS concentrations in the aqueous solution, adsorption occurs more rapidly within a suspended or agitated solution. If the nano- or micro-bubble ozone is later sent through the canister 300, adsorbed PFAS compounds can be released and oxidized over a longer period of exposure to the ozone solution (e.g., 2 to 8 hours).

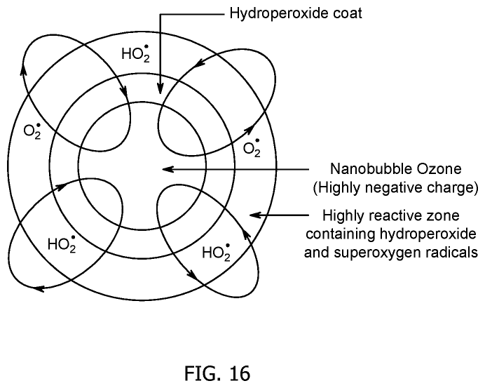

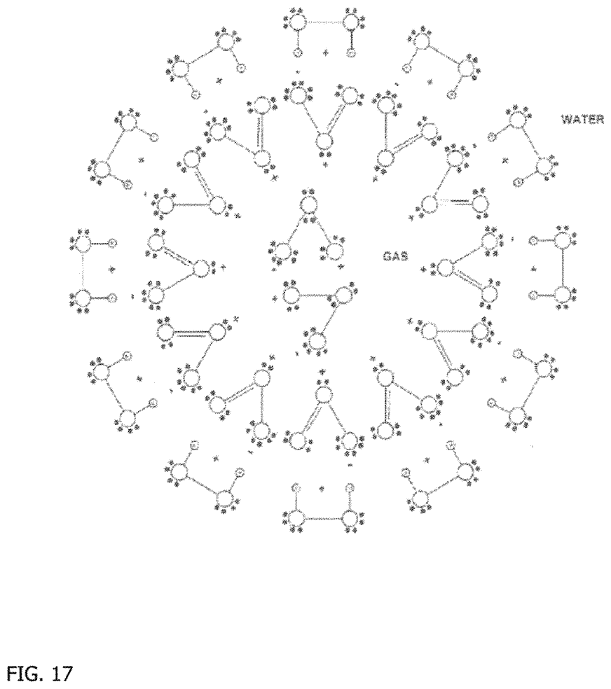

In embodiments of the present invention, peroxide-coated ozone bubbles may be used for treatment of contaminated soil and groundwater, either with the removal system illustrated in FIG. 1 or with the stand-alone catalytic adsorption canister embodiments illustrated in FIGS. 14-15. An example of peroxide-coated ozone bubbles is given in U.S. Pat. No. 9,694,401 to Kerfoot, titled “Method and Apparatus for Treating Perfluoroalkyl Compounds” and incorporated herein by reference. FIG. 16 shows a schematic diagram of an ozone nanobubble. FIG. 17 shows provides a schematic diagram of the molecular structure of an ozone nanobubble. As shown, an organized spherical film-like form of ozone and hydrogen peroxide present in nanobubbles.

From the immediate observations of the reactions of degradation of the PFOS, it was hypothesized that a set of 3 reactions are occurring.

Firstly, ozone reacts with peroxide to yield superoxide (O₂.) and hydroperoxide (HO₂.) radicals. In reactions generating either O₂, or HO₂., PFOS is degraded rapidly by nucleophilic attack.

Hydroperoxide anion, the conjugate base of H₂O₂, is known to react with O₃ to form hydroxyl radicals and superoxide radicals.

H₂O₂+H₂O↔HO₂⁻+HO₃+HO₂⁻→OH+O₂⁻+O₂

Secondly, the stoichiometry of the reaction results in the release of abundant fluoride ions, oxygen, carbon dioxide, and likely two moles of sulfate.

2C₈F₁₇SO₃H+27H₂O₂+9O₃→16CO₂+27H₂O₂+2 SO₃⁻²+34 F⁻+27 O₂

Thirdly, the hydrofluoric acid reacts with iron silica aggregates in the soil to release iron and form fluorosilicates which likely volatilize from the heated mixture. Any free fluorine atoms are likely to react with free carbon. If low molecular weight CFs, they may also volatilize off.

4HF+SiO₂(s)+Fe⁻²→Fe(s)↓+SiF₄(g)↑+2H₂O

TABLE 3
Removal of PF Compounds from Groundwater
(GSI) with Nanozox ™ Treatment (1260 ppmV
O3, 10% H₂O₂).

| PFC | START | 1 HR | 2 HR | 3 HR | % REMOVAL |
|---|---|---|---|---|---|
| PFGS | 430 | 150 | 160 | 76 | 82.3 |
| PFOA | 34 | 17 | 13 | 9 | 73.6 |
| PFHxS | 300 | 100 | 110 | 42 | 86 |
| PFHxA | 270 | 110 | 150 | 86 | 69.2 |
| PFPeA | 84 | 27 | 23 | 15 | 82.1 |

TABLE 4
Removal of PF Compounds in Groundwater Over Soil Slurry

| PFC | START | 30 MIN | 60 MIN | 120 MIN | % REMOVAL |
|---|---|---|---|---|---|
| PFOS | 430 | 340 | 33 | 44 | 89.8 |
| PFOA | 34 | 22 | 4 | 3 | 91.2 |
| PFHxS | 300 | 87 | 14 | 8 | 97.4 |
| PFHxA | 270 | 75 | 34 | 23 | 91.5 |
| PFPeA | 84 | 13 | 8 | 6 | 92.9 |

In the mixture of the present invention, ozone is ideally retained in the form of nanobubbles (<1 micron size) as shown in the particle size depiction of FIGS. 16 and 17. The ozone nanobubbles are formed by supplying a high concentration of ozone (greater than one percent) and oxygen (both combined to greater than 90% gas) to the interior of the film to create a high negative charge which is then coated with a hydroperoxide (slightly positive charge). The extremely fine bubbles create an emulsion (greater than 10 million bubbles per liter) appearing milky white by reflected light. Under reaction, with temperature rise beyond 40° C., the normal hydroxyl-radical dominated outer zone of the bubble film is changed in nature to hydroperoxide and superoxygen radicals, raising the oxidation potential from 2.8 to beyond 2.9 volts, capable of directly cleaving the carbon-fluoride bond, which has a bond strength of 3.6 volts. In some embodiments, the oxidation potential is between 2.8 and 3.6 volts. In some embodiments, the oxidation potential is between 2.9 and 3.6 volts. In other embodiments, the oxidation potential is between 2.9 and 3.0, 2.9 and 3.1, 2.9 and 3.2, 2.9 and 3.3, 2.9 and 3.4, or 2.9 and 3.5 volts. In some embodiments, the oxidation potential is between 3.0 and 3.6, 3.1 and 3.6, 3.2 and 3.6, 3.3 and 3.6, 3.4 and 3.6, or 3.5 and 3.6 volts.

A reaction mechanism for the Perozone-3.0 radical mediated degradation of perfluoroalkyl carboxylates could follow the pathway similar to persulfate radical. The initial degradation is postulated to occur through an electron transfer from the carboxy late terminal group to the hydroperoxide radical (Equation 1.0). The superoxygen provides additional reduction. The oxidized PFOA subsequently decarboxylates to form a perfluoroheptyl radical (Equation 1.1) which reacts quantitatively with molecular oxygen to form a perfluoroheptylperoxy radical (Equation 1.2). The pertluoroheptylperoxy radical will react with another perfluoroheptylperoxy radical in solution, since there are limited reductants present to yield two perfluoroalkoxy radicals and molecular oxygen (Equation 1.3). The perfluoroheptyloxy has a main pathway (Equation 1.4)—unimolecular decomposition to yield the perfluorohexyl radical and carbonyl fluoride. The perfluorohexyl radical formed with react with Oz and resume the radical “unzipping” cycle. The COF₂ will hydrolyze to yield CO₂ and two HF (Equation 1.5). The perfluoroheptanol will unimolecularily decompose to give the perfluoroheptylacyl fluoride and HF.

CF₃(CF₂)₆COO⁻+HO₂+O₂⁻→CF₃(CF₂)₆COO+HO₂⁻+O₂ (1.0)

CF₃(CF₂)₆COO→CF₃(CF₂)₅CF₂+CO₂ (1.1)

CF₃(CF₂)₅CF₂+O₂→CF₃(CF₂)₅CF₂OO (1.2)

CF₃(CF₂)₅CF₂OO+RFOO→CF₃(CF₂)₅CF₂O+RFO+O₂ (1.3)

CF₃(CF₂)₅CF₂O→CF₃(CF₂)₄CF₂+COF₂ (1.4)

COF₂+H₂O→CO₂+2HF (1.5)

Advantages of the removal system as disclosed above include activated fine bubble ozone has the capacity to remove over 90% C₆^{F}-C₈^{F} PFASs and 6:2/8:2 fluorotelomere sulfonate precursors in in-situ groundwater, independent of the functional group. Coupling the process with recirculation and above-ground sorbent/AC treatment may yield above 99% treatment. Adsorber activated carbon does not require immediate replacement due to periodic treatment with ozone or other oxidizer used in recirculation well system. Direct groundwater flow characterization may confirm isolation of containment site.

Great results have also been identified using the apparatus and methods of the present invention with just ozone in combination with the adsorptive mineral catalyst. By combining adsorption with a mineral catalyst that initiates the unzipping of the alkane C—F backbone of the perfluoroalkane molecule in the presence of ozone, the perfluoro compound can be mineralized efficiently and effectively. Moreover, the small size of the ozone bubbles (i.e., almost cloud-like nano- and micro-bubbles) increases reactivity on the surface of the mineral catalyst, which speeds up the rate of decomposition to match or exceed processes using peroxide ozone.

FIG. 18 shows test results for removal of various PFAS compounds over time using treatment methods in accordance with the present invention with mineral-catalyzed ozone bubble, which data are also provided in Table 5 below. FIG. 19 shows test results for removal of PFAS compounds over time using ozone bubbles in comparison with peroxide-coated ozone bubbles.

TABLE 5
Removal of PF Compounds using
Mineral-Catalyzed Ozone Bubbles

| PFAS | 0 Hours | 2 Hours | 4 Hours | 6 Hours |
|---|---|---|---|---|
| PFNA | 100% | 64.5% | 32.2% | 22.5% |
| PFDA | 100% | 29.0% | 11.9% | N/A |
| PFOS | 100% | 33.2% | 16.6% | 13.0% |

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An apparatus for treatment of contaminated groundwater or soil, said apparatus comprising:
a well comprising at least one diffuser for injecting gaseous ozone as bubbles into water in the groundwater or soil formation;
a catalytic adsorption canister comprising an inlet for receiving gaseous ozone bubbles and at least one outlet coupled to the groundwater or soil formation;
a control mechanism for supplying gaseous ozone to the well and the catalytic adsorption canister; and
a pump in the well, the pump further comprising an inlet for receiving groundwater from an upper portion of the well, a first outlet coupled to a lower portion of the well and a second outlet coupled to the inlet of the catalytic adsorption canister.

2. The apparatus of claim 1, wherein the catalytic adsorption canister further comprises an upper adsorber region comprising a mineral catalyst and a lower adsorber region comprising activated carbon.

3. The apparatus of claim 2, wherein the mineral catalyst comprises an iron silicate with an iron content greater than 3%.

4. The apparatus of claim 1, wherein the at least one diffuser in the well comprises a plurality of diffusers arranged in series.

5. The apparatus of claim 1, wherein the at least one diffuser is operatively coupled to the control mechanism for receiving gaseous ozone and producing bubbles that are introduced into the groundwater or soil formation to effect removal of PFAS compounds.

6. The apparatus of claim 1, wherein the control mechanism further supplies hydroperoxide.

7. The apparatus of claim 6, wherein the at least one diffuser is operatively coupled to the control mechanism for receiving gaseous ozone and liquid hydroperoxide and producing a plurality of peroxide-coated ozone bubbles that are introduced into the groundwater or soil formation to effect removal of PFAS compounds.

8. The apparatus of claim 7, wherein each of the plurality of peroxide-coated ozone bubbles has a diameter less than about 10 μm wherein the bubbles have an oxidation potential greater than or equal to 2.9 volts and less than or equal to 3.6 volts, and wherein the bubbles contain gas phase ozone at a concentration greater than or equal to 1000 ppmV.

9. The apparatus of claim 6, wherein the control mechanism supplies peroxide-coated ozone bubbles to the catalytic adsorption canister.

10. The apparatus of claim 1, wherein the control mechanism further supplies sodium hydroxide or potassium hydroxide.

11. The apparatus of claim 1, wherein the quantity of groundwater sent to the first and second outlets of the pump is adjustable.

12. A method for treatment of contaminated groundwater or soil comprising:
injecting gaseous ozone through porous materials in a well to introduce bubbles through an outlet in the well into the groundwater or soil formation at concentrations sufficient to react with, and effect removal of, one or more PFAS contaminants in the groundwater or soil formation;
pumping groundwater from an inlet in the well to the outlet and to a catalytic adsorption canister;
coupling an outlet of the catalytic adsorption canister to the groundwater or soil formation; and
injecting gaseous ozone into the catalytic adsorption canister to mineralize the PFAS contaminants.

13. The method of claim 12, wherein the catalytic adsorption canister further comprises an upper adsorber region comprising a mineral catalyst and a lower adsorber region comprising activated carbon.

14. The method of claim 13, wherein the mineral catalyst in the upper adsorber region comprises an iron silicate having an iron content greater than 3%.

15. The method of claim 12, further comprising the step of injecting gaseous ozone into the groundwater or soil formation at a plurality of points along a vertical axis.

16. The method of claim 12, further comprising the step of injecting a plurality of peroxide-coated ozone bubbles into the soil formation to effect removal of PFAS compounds.

17. The method of claim 16, wherein each of the plurality of peroxide-coated ozone bubbles has a diameter less than about 10 μm, wherein the bubbles have an oxidation potential greater than or equal to 2.9 volts and less than or equal to 3.6 volts, and wherein the bubbles contain gas phase ozone at a concentration greater than or equal to 1000 ppmV.

18. The method of claim 16, further comprising the step of injecting peroxide-coated ozone bubbles to the catalytic adsorption canister.

19. The method of claim 12, wherein the quantity of groundwater sent to the outlet of the well and the catalytic adsorption canister is adjustable.

20. A catalytic adsorption canister for treatment of contaminated water include PFAS compounds, said catalytic adsorption canister comprising:
an upper adsorber chamber including a mineral or sand-based catalyst;
a lower adsorber chamber including activated carbon or charcoal;
a first inlet for receiving water for treatment;
a second inlet for receiving gaseous ozone bubbles; and
an outlet for discharge of treated water,
wherein the mineral catalyst in the upper adsorber chamber adsorbs PFAS compounds in contaminated water introduced to the upper adsorber chamber, and further wherein, in the presence of the gaseous ozone bubbles, the PFAS compounds are mineralized.
